(19) United States
(12) Patent Application Publication
(10) Pub. No.: US 2025/0362550 A1
(43) Pub. Date: Nov. 27, 2025

(54) LIQUID CRYSTAL ELEMENT

(71) Applicant: Japan Display Inc., Tokyo (JP)

(72) Inventors: Shunichi KIMURA, Tokyo (JP); Toshiharu MATSUSHIMA, Tokyo (JP)

(21) Appl. No.: 19/213,538

(22) Filed: May 20, 2025

(30) Foreign Application Priority Data
May 22, 2024 (JP) 2024-083189

(51) Int. Cl. G02F 1/1343; G02F 1/1335

(52) U.S. Cl. CPC G02F 1/134309; G02F 1/133512

(57) ABSTRACT

A liquid crystal element includes: a first substrate on which element sets each including an electric resistance film, a first electrode, and a second electrode are disposed, the first and second electrodes being electrically coupled to the electric resistance film; a second substrate on which third electrodes and fourth electrodes are disposed; and a liquid crystal layer between the first substrate and the second substrate. The electric resistance film extends in a first direction. The first and second electrodes extend in the first direction, face each other in a second direction, and overlap the electric resistance film. The element sets are arranged in the second direction. Each third electrode extends in the first direction and overlaps the first electrode of a corresponding one of the element sets. Each fourth electrode extends in the first direction and overlaps the second electrode of a corresponding one of the element sets.

### CROSS-REFERENCE TO RELATED APPLICATION

This application claims the benefit of priority from Japanese Patent Application No. 2024-083189 filed on May 22, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2015-174551 (JP-A-2015-174551) discloses a headlight capable of controlling light distribution. The headlight of JP-A-2015-174551 reflects light from a light source by using a mirror, converges the reflected light with a lens, and projects light toward the front of the vehicle. The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first arm and the second arm and the angle between the lamp unit and the second arm.

In a device capable of adjusting the emission direction of light as in JP-A-2015-174551 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate on which a plurality of element sets each including an electric resistance film, a first electrode, and a second electrode are disposed, the first electrode and the second electrode being electrically coupled to the electric resistance film; a second substrate on which a plurality of third electrodes and a plurality of fourth electrodes are disposed; and a liquid crystal layer positioned between the first substrate and the second substrate. The electric resistance film extends in a first direction in plan view. The first electrode and the second electrode, in plan view, extend in the first direction and overlap the electric resistance film in a state in which the first electrode and the second electrode face each other in a second direction orthogonal to the first direction. The element sets are arranged in the second direction in plan view. Each of the third electrodes extends in the first direction and overlaps the first electrode of a corresponding one of the element sets in plan view. Each of the fourth electrodes extends in the first direction and overlaps the second electrode of a corresponding one of the element sets in plan view.

### BRIEF DESCRIPTION OF THE DRAWINGS

FIG. 1 is a conceptual diagram of a liquid crystal element according to an embodiment of the present disclosure;

FIG. 2 is a plan view of the liquid crystal element according to the embodiment of the present disclosure;

FIG. 3 is a sectional view of the liquid crystal element along line III-III illustrated in FIG. 2;

FIG. 4 is a plan view illustrating an arrangement of electric resistance films, first electrodes, and second electrodes;

FIG. 5 is a plan view illustrating an arrangement of third electrodes and fourth electrodes;

FIG. 6 is a diagram illustrating the tilt degree of liquid crystal molecules when the liquid crystal element refracts emission light in a fourth direction;

FIG. 7 is a diagram illustrating the phase difference of emission light passing through a liquid crystal layer of the liquid crystal element illustrated in FIG. 6;

FIG. 8 is a sectional view of a liquid crystal element of a comparative example;

FIG. 9 is a diagram illustrating the tilt degrees of liquid crystal molecules when the liquid crystal element of the comparative example refracts emission light in the fourth direction;

FIG. 10 is a sectional view of a liquid crystal element according to a first modification of the embodiment of the present disclosure; and

FIG. 11 is a sectional view of a liquid crystal element according to a second modification of the embodiment of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

A first direction D1 and a second direction D2 illustrated in the drawings correspond to directions parallel to the plate surfaces of substrates included in a liquid crystal element 1 to be described later. The first direction D1 and the second direction D2 correspond to sides of the liquid crystal element 1. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the liquid crystal element 1. In the third direction D3, a side indicated by an arrow is a positive D3 side, and a side opposite to the positive D3 side is a negative D3 side. The positive D3 side in the third direction D3 corresponds to the front surface side of the liquid crystal element 1, and the negative D3 side in the third direction D3 corresponds to the back surface side of the liquid crystal element 1. In the present specification, “plan view” is a view when the liquid crystal element 1 is viewed in the third direction D3. The first direction D1, the second direction D2, and the third direction D3 are exemplary, and the present disclosure is not limited to these directions.

In this disclosure, when an element is described as being “on” another element, the element can be directly on the other element, or there can be one or more elements between the element and the other element.

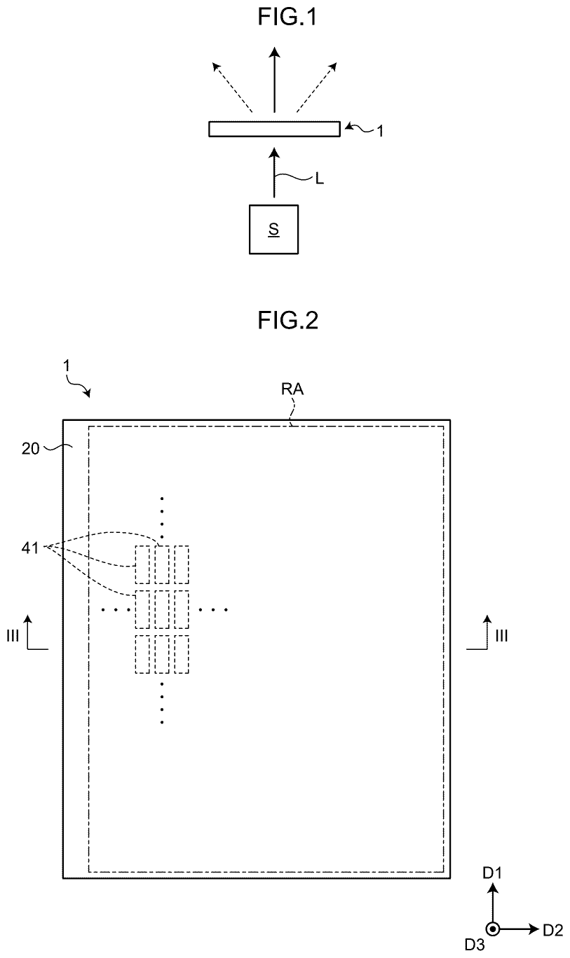

FIG. 1 is a conceptual diagram of the liquid crystal element 1 according to an embodiment of the present disclosure. The liquid crystal element 1 is a refractive plate that refracts light. Emission light L emitted from a light source S enters the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

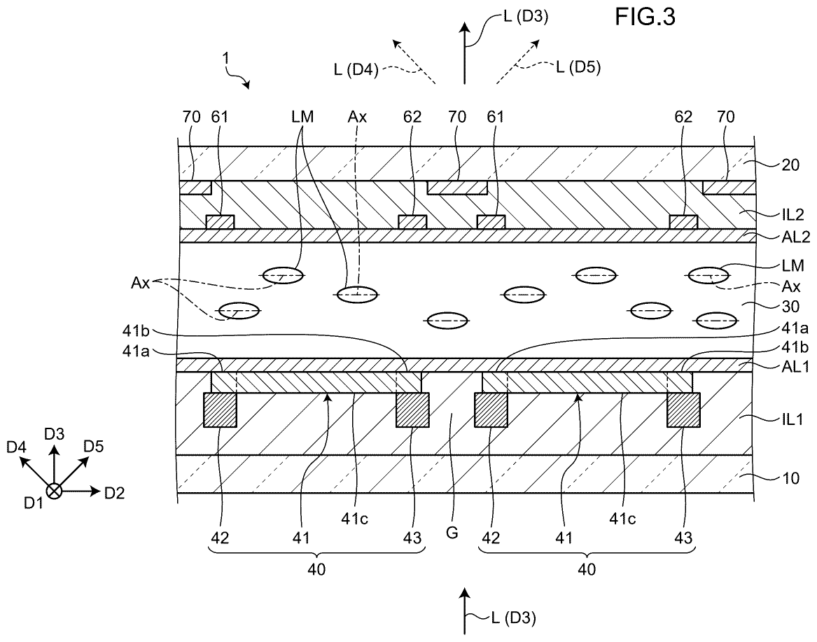

FIG. 2 is a plan view of the liquid crystal element 1 according to the embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30.

The first substrate 10 and the second substrate 20 face each other. The first substrate 10 and the second substrate 20 have a light-transmitting property. The first substrate 10 and the second substrate 20 are, for example, glass substrates, resin substrates, or resin films.

A plurality of element sets 40, a first insulating layer IL1, and a first alignment film AL1 are disposed on the first substrate 10. Each element set 40 includes an electric resistance film 41, a first electrode 42, and a second electrode 43.

As illustrated in FIG. 2, the electric resistance films 41 are arranged in a matrix having a row-column configuration in the first direction D1 and the second direction D2 in plan view. The electric resistance films 41 extend in the first direction D1 in plan view. Specifically, in plan view, the electric resistance films 41 each have a rectangular shape with the length of the first direction D1 being longer than the length of the second direction D2. In plan view, the electric resistance films 41 overlap a refraction region RA that refracts the emission light L.

The electric resistance value of the electric resistance film 41 is larger than the electric resistance values of the first electrode 42 and the second electrode 43. The material of the electric resistance film 41 is a conductive material having a light-transmitting property, such as indium tin oxide (ITO), zinc oxide (ZnO), or indium gallium zinc oxide (IGZO).

As illustrated in FIG. 3, the first electrode 42 and the second electrode 43 are disposed on the back surface side of the electric resistance films 41.

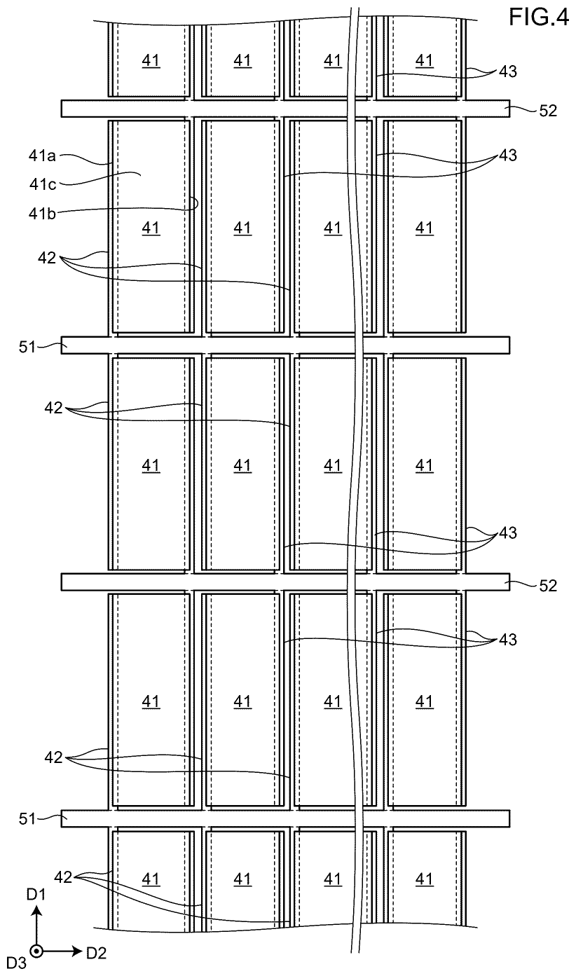

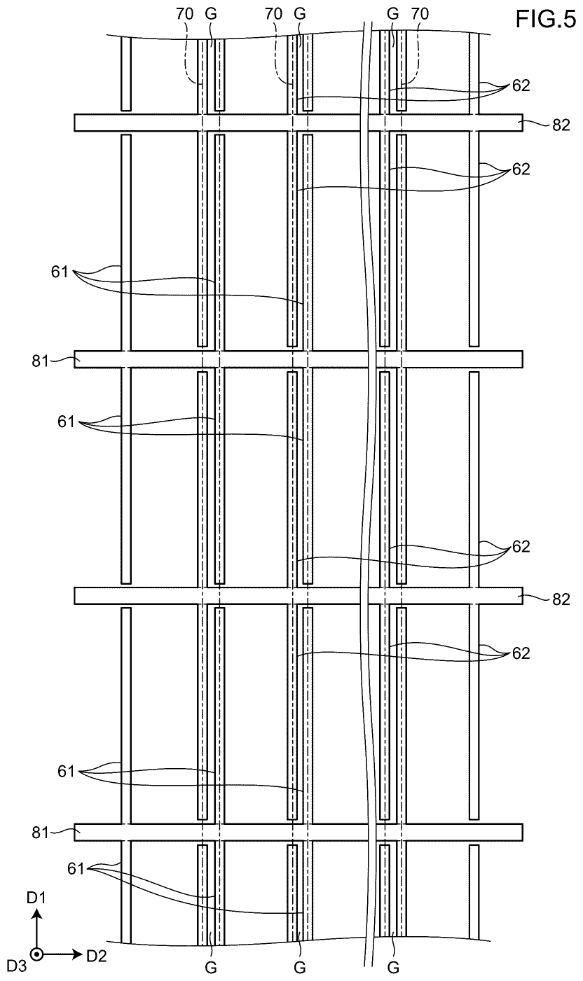

FIG. 4 is a plan view illustrating an arrangement of the electric resistance films 41, the first electrodes 42, and the second electrodes 43. The liquid crystal element 1 further includes a plurality of first trunk electrodes 51 and a plurality of second trunk electrodes 52 disposed on the first substrate 10.

The first trunk electrodes 51 extend in the second direction D2. The first trunk electrodes 51 are each positioned between two electric resistance films 41 adjacent to each other in the first direction D1. The first trunk electrodes 51 are separated from the electric resistance films 41 in plan view.

Each first trunk electrode 51 is electrically coupled to more than one of the first electrodes 42. The first trunk electrode 51 is integrated with the more than one of the first electrodes 42. The more than one of the first electrodes 42 are electrically coupled to the first trunk electrode 51 such that they protrude from the first trunk electrode 51 toward both sides in the first direction D1. The first electrodes 42 extend in the first direction D1. Each first electrode 42 electrically couples two electric resistance films 41 adjacent to each other with the first trunk electrode 51 interposed therebetween in the first direction D1.

As illustrated in FIGS. 3 and 4, the first electrodes 42 are arranged in the second direction D2 and each overlap an end part of an electric resistance film 41 on the negative D2 side in the second direction D2 in plan view and are each electrically coupled thereto. The first electrode 42 contacts the electric resistance film 41.

The second trunk electrodes 52 extend in the second direction D2. The second trunk electrodes 52 are each positioned between two electric resistance films 41 adjacent to each other in the first direction D1. The second trunk electrodes 52 are separated from the electric resistance films 41 in plan view.

For each electric resistance film 41, the first trunk electrode 51 and the second trunk electrode 52 are disposed on opposite sides with the electric resistance film 41 interposed therebetween in the first direction D1. In other words, the first and second trunk electrodes 51 and 52 are alternately arranged in the first direction D1.

Each second trunk electrode 52 is electrically coupled to more than one of the second electrodes 43. The second trunk electrode 52 is integrated with the more than one of the second electrodes 43. The more than one of the second electrodes 43 are electrically coupled to the second trunk electrode 52 such that they protrude from the second trunk electrode 52 toward both sides in the first direction D1. The second electrodes 43 extend in the first direction D1. Each second electrode 43 electrically couples two electric resistance films 41 adjacent to each other with the second trunk electrode 52 interposed therebetween in the first direction D1.

As illustrated in FIGS. 3 and 4, a plurality of second electrodes 43 are arranged in the second direction D2 and each overlap an end part of an electric resistance film 41 on the positive D2 side in the second direction D2 in plan view and are electrically coupled thereto. The second electrode 43 contacts the electric resistance film 41. In each element set 40, the first electrode 42 and the second electrode 43 are electrically coupled to the electric resistance film 41 in a state of facing each other in the second direction D2.

The length in the first direction D1 of a portion of the first electrode 42 electrically coupled to the end part of the electric resistance film 41 is equal to the length in the first direction D1 of a portion of the second electrode 43 electrically coupled to the electric resistance film 41. The sectional shape of the first electrode 42 is the same as the sectional shape of the second electrode 43. Accordingly, the length of the first electrode 42 in the second direction D2 is equal to the length of the second electrode 43 in the second direction D2.

As the electric resistance films 41, the first electrodes 42, and the second electrodes 43 are disposed in this manner, the element sets 40 are arranged in a matrix having a row-column configuration in the first direction D1 and the second direction D2.

The material of the first electrodes 42, the second electrodes 43, the first trunk electrodes 51, and the second trunk electrodes 52 is a conductive material such as molybdenum tungsten alloy (MoW) or TAT (Ti/Al/Ti) in which titanium (Ti) and aluminum (Al) are stacked.

The first and second trunk electrodes 51 and 52 are electrically coupled to a non-illustrated control circuit. The control circuit applies voltage to the first electrodes 42 through the first trunk electrodes 51. The control circuit applies voltage to the second electrodes 43 through the second trunk electrodes 52.

As illustrated in FIGS. 3 and 4, in the electric resistance film 41, a portion overlapping the first electrode 42 in plan view is a first overlap portion 41a, a portion overlapping the second electrode 43 in plan view is a second overlap portion 41b, and a portion between the first overlap portion 41a and the second overlap portion 41b is a middle portion 41c. In the second direction D2, the length of the middle portion 41c is longer than the sum of the length of the first overlap portion 41a and the length of the second overlap portion 41b.

In the present embodiment, in the second direction D2, the end of the first electrode 42 on the negative D2 side is positioned on the negative D2 side of the end of the electric resistance film 41 on the negative D2 side, and the end of the second electrode 43 on the positive D2 side is positioned on the positive D2 side of the end of the electric resistance film 41 on the positive D2 side. In the second direction D2, the end of the first electrode 42 on the negative D2 side may coincide with the end of the electric resistance film 41 on the negative D2 side, and the end of the second electrode 43 on the positive D2 side may coincide with the end of the electric resistance film 41 on the positive D2 side.

The first insulating layer IL1 illustrated in FIG. 3 electrically insulates the electric resistance films 41, the first trunk electrodes 51, and the second trunk electrodes 52 from one another. The first insulating layer IL1 also electrically insulates the first electrodes 42 and the second electrodes 43 from each other.

The first alignment film AL1 is disposed on the front surface side of the electric resistance film 41.

A plurality of third electrodes 61, a plurality of fourth electrodes 62, a second insulating layer IL2, a plurality of light-shielding films 70, and a second alignment film AL2 are disposed on the second substrate 20.

FIG. 5 is a plan view illustrating an arrangement of the third electrodes 61 and the fourth electrodes 62. The liquid crystal element 1 further includes a plurality of third trunk electrodes 81 and a plurality of fourth trunk electrodes 82 disposed on the second substrate 20.

The third trunk electrodes 81 extend in the second direction D2. The third trunk electrodes 81 overlap the first trunk electrodes 51 in plan view. Specifically, the third trunk electrodes 81 are each positioned between two electric resistance films 41 adjacent to each other in the first direction D1. The third trunk electrodes 81 are separated from the electric resistance films 41 in plan view.

Each third trunk electrode 81 is electrically coupled to more than one of the third electrodes 61. The third trunk electrode 81 is integrated with the more than one of the third electrodes 61. The more than one of the third electrodes 61 are electrically coupled to the third trunk electrode 81 such that they protrude from the third trunk electrode 81 toward both sides in the first direction D1. The third electrodes 61 extend in the first direction D1. As illustrated in FIG. 3, the third electrodes 61 overlap the first electrodes 42 in plan view. The third electrodes 61 may partially overlap the first electrodes 42 in plan view.

As illustrated in FIG. 5, the fourth trunk electrodes 82 extend in the second direction D2. The fourth trunk electrodes 82 overlap the second trunk electrodes 52 in plan view. Specifically, the fourth trunk electrodes 82 are each positioned between two electric resistance films 41 adjacent to each other in the first direction D1. The fourth trunk electrodes 82 are separated from the electric resistance films 41 in plan view. The third and fourth trunk electrodes 81 and 82 are alternately arranged in the first direction D1.

Each fourth trunk electrode 82 is electrically coupled to more than one of the fourth electrodes 62. The more than one of the fourth trunk electrode 82 is integrated with the fourth electrodes 62. The more than one of the fourth electrodes 62 are electrically coupled to the fourth trunk electrode 82 such that they protrude from the fourth trunk electrode 82 toward both sides in the first direction D1. The fourth electrodes 62 extend in the first direction D1. As illustrated in FIG. 3, the fourth electrodes 62 overlap the second electrodes 43 in plan view. The fourth electrodes 62 may partially overlap the second electrodes 43 in plan view.

The material of the third electrodes 61, the fourth electrodes 62, the third trunk electrodes 81, and the fourth trunk electrodes 82 is a conductive material having a light-transmitting property, such as indium tin oxide (ITO), indium zinc oxide (IZO), indium gallium oxide (IGO), or indium gallium zinc oxide (IGZO). The material of the third electrodes 61, the fourth electrodes 62, the third trunk electrodes 81, and the fourth trunk electrodes 82 may be a conductive material such as molybdenum tungsten alloy (MoW) or TAT (Ti/Al/Ti) in which titanium (Ti) and aluminum (Al) are stacked.

The third and fourth trunk electrodes 81 and 82 are electrically coupled to a non-illustrated control circuit. The control circuit applies voltage to the third electrodes 61 through the third trunk electrodes 81. The control circuit applies voltage to the fourth electrodes 62 through the fourth trunk electrodes 82.

The second insulating layer IL2 illustrated in FIG. 3 electrically insulates the third trunk electrodes 81 and the fourth trunk electrodes 82 from each other. The second insulating layer IL2 also electrically insulates the third electrodes 61 and the fourth electrodes 62 from each other.

The second alignment film AL2 is disposed on the back surface side of each of the third electrodes 61 and the fourth electrodes 62.

The light-shielding films 70 interrupt light transmission. The light-shielding films 70 have conductivity. The material of the light-shielding film 70 is, for example, molybdenum tungsten alloy (MoW). The light-shielding films 70 are disposed on the second substrate 20. The light-shielding films 70 are positioned between the second substrate 20 and the second insulating layer IL2. Each of the light-shielding films 70 overlap a gap G between two element sets 40 adjacent to each other in the second direction D2 in plan view. The light-shielding films 70 may be disposed on the first substrate 10.

In FIG. 5, the light-shielding films 70 are illustrated with dashed and single-dotted lines. The light-shielding films 70 each have a strip shape extending in the first direction D1. As illustrated in FIG. 3, the length of each element set 40 is longer than the length of each gap G in the second direction D2.

The liquid crystal layer 30 illustrated in FIG. 3 is positioned between the first substrate 10 and the second substrate 20. The liquid crystal layer 30 is sandwiched between the first alignment film AL1 and the second alignment film AL2. The first alignment film AL1 and the second alignment film AL2 define the alignment (initial orientation) of liquid crystal molecules LM contained in the liquid crystal layer 30 when no voltage is applied to the liquid crystal element 1. The initial orientation of the liquid crystal molecules LM is in such an orientation (horizontal orientation) that a long axis Ax of each liquid crystal molecule LM is orthogonal to the third direction D3. The alignment direction of the first alignment film AL1 and the alignment direction of the second alignment film AL2 are parallel to each other in plan view.

The liquid crystal element 1 is an electrically controlled birefringence (ECB) liquid crystal element. However, the liquid crystal element 1 is not limited to an ECB liquid crystal element.

The following describes operation when the liquid crystal element 1 refracts the emission light L from the light source S. Voltage is applied to the first electrodes 42, the second electrodes 43, the third electrodes 61, and the fourth electrodes 62 by a control circuit to refract the emission light L. The emission light L enters the liquid crystal element 1 in the third direction D3 from the back surface of the first substrate 10. A reference sign inside parentheses given to the emission light L indicates the direction in which the emission light L travels. In FIG. 3, the emission light L from the liquid crystal element 1 is illustrated on the positive D3 side of the liquid crystal element 1.

When no voltage is applied to the first electrodes 42, the second electrodes 43, the third electrodes 61, and the fourth electrodes 62, the alignment states of all liquid crystal molecules LM included in the liquid crystal layer 30 are in initial orientation (horizontal orientation) and all liquid crystal molecules LM have the same tilt degree. Thus, the phase change amount of the emission light L passing through the liquid crystal layer 30 is equal at all portions of the liquid crystal layer 30, and no phase difference occurs to the emission light L. Accordingly, the liquid crystal element 1 allows the emission light L to exit therefrom without refraction. Specifically, as illustrated in FIG. 3, when the emission light L enters the liquid crystal element 1 along the third direction D3, the liquid crystal element 1 allows the emission light L to exit therefrom along the third direction D3 without refraction.

When the liquid crystal element 1 refracts the emission light L from the light source S, voltage is applied to the first electrodes 42, the second electrodes 43, the third electrodes 61, and the fourth electrodes 62 such that the magnitude of a first potential difference between the potential of the first electrodes 42 and the potential of the third electrodes 61 is different from the magnitude of a second potential difference between the potential of the second electrodes 43 and the potential of the fourth electrodes 62. Hereinafter, the first electrodes 42, the second electrodes 43, the third electrodes 61, and the fourth electrodes 62 are simply referred to as “electrodes” when described without distinction.

Specifically, when the liquid crystal element 1 refracts the emission light L so that the light travels in a fourth direction D4 tilted to the negative D2 side relative to the third direction D3, voltage is applied to the electrodes such that the magnitude of the second potential difference is larger than the magnitude of the first potential difference.

In this case, from the first electrode 42 side toward the second electrode 43 side in the second direction D2, the potential of the electric resistance film 41 changes from the potential of the first electrode 42 to the potential of the second electrode 43.

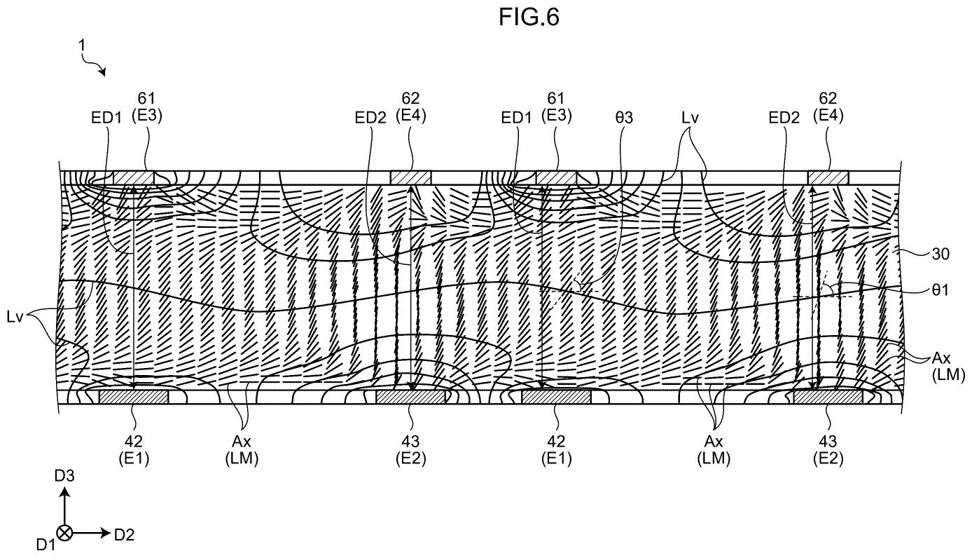

FIG. 6 is a diagram illustrating the tilt degree of the liquid crystal molecules LM when the liquid crystal element 1 refracts the emission light L in the fourth direction D4. In FIG. 6, the liquid crystal molecules LM are represented only by the long axes Ax of the liquid crystal molecules LM. Potential lines Lv of an electric field and the like generated in the liquid crystal layer 30 are illustrated in FIG. 6. The initial orientation of the liquid crystal molecules LM is horizontal orientation as described above. Accordingly, when no voltage is applied to the electrodes, the long axes Ax of the liquid crystal molecules LM align with the second direction D2.

When voltage is applied to the electrodes, an electric field acts on the liquid crystal layer 30, causing the liquid crystal molecules LM to tilt. As the magnitude of the potential difference in the third direction D3 increases in the liquid crystal layer 30, the tilt degree of the liquid crystal molecules LM increases (in other words, the angles of the long axes Ax of the liquid crystal molecules LM relative to the second direction D2 increase).

As the tilt degree of the liquid crystal molecules LM increases, the phase of the emission light L passing through the liquid crystal layer 30 advances. In other words, as the magnitude of the potential difference in the third direction D3 in the liquid crystal layer 30 increases, the phase of the emission light L advances.

FIG. 6 illustrates a state in which voltage is applied to the electrodes such that the magnitude (ED2) of the second potential difference between the second electrodes 43 and the fourth electrodes 62 becomes larger than the magnitude (ED1) of the first potential difference between the first electrodes 42 and the third electrodes 61 (ED1<ED2). Accordingly, in FIG. 6, the tilt degree of the liquid crystal molecules LM between the second and fourth electrodes 43 and 62 is larger than the tilt degree of the liquid crystal molecules LM between the first and third electrodes 42 and 61. From the first electrodes 42 toward the second electrodes 43 in the second direction D2, the magnitude of the potential difference in the third direction D3 and the tilt degree of the liquid crystal molecules LM increase.

Voltage is applied to the first electrodes 42, the second electrodes 43, the third electrodes 61, and the fourth electrodes 62 such that the potential of the first electrodes 42 is different from the potential of the second electrodes 43 and the potential of the third electrodes 61 is different from the potential of the fourth electrodes 62. Accordingly, potential difference occurs between the potential of the first electrodes 42 and the potential of the second electrodes 43. Potential difference occurs between the potential of the third electrodes 61 and the potential of the fourth electrodes 62.

In the state illustrated in FIG. 6, voltage is applied to the electrodes such that the potential (E2) of the second electrodes 43 is larger than the potential (E1) of the first electrodes 42 (E1<E2) and the potential (E3) of the third electrodes 61 is larger than the potential (E4) of the fourth electrodes 62 (E4<E3).

In FIG. 6, the potential (E3) of the third electrodes 61 is larger than the potential (E1) of the first electrodes 42 (E1<E3), the potential (E1) of the first electrodes 42 is larger than the potential (E4) of the fourth electrodes 62 (E4<E1), and the potential (E2) of the second electrodes 43 is equal to the potential (E3) of the third electrodes 61 (E2=E3). Thus, the electrode potential relation in FIG. 6 is expressed by Expression (1) below.

$$E 4 < E 1 < E 2 = E 3 \qquad ( 1 )$$

Moreover, in FIG. 6, the potential (E2) of the second electrodes 43 and the potential (E4) of the fourth electrodes 62 have the same magnitude but opposite polarities as expressed by Expression (2).

$$E 2 = ( - 1 ) \times E 4 \qquad ( 2 )$$

When the electrode potential relation satisfies the relation of Expressions (1) and (2), the electrode potential can be controlled by a column inversion driving method in which the polarity of the electrode potential is periodically inverted. The electrode potential relation is not limited to the relation of Expressions (1) and (2).

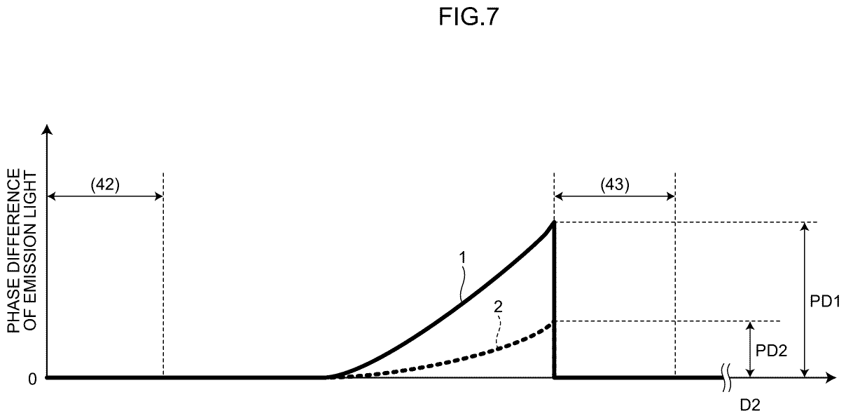

FIG. 7 is a diagram illustrating the phase difference of the emission light L passing through the liquid crystal layer 30 of the liquid crystal element 1 illustrated in FIG. 6. FIG. 7 illustrates a case where the electrode potential relation is the relation represented by Expressions (1) and (2) and voltage is applied to the electrodes such that the magnitude (ED2 (=|E4−E2|)) of the second potential difference is approximately twice the magnitude (ED1 (=|E3−E1|)) of the first potential difference. The vertical axis in FIG. 7 represents the phase difference of the emission light L. The horizontal axis in FIG. 7 represents the position in the second direction D2 in the liquid crystal layer 30. In FIG. 7, the portion of “(42)” represents the region of a first electrode 42 in the second direction D2, and the portion of “(43)” represents the region of a second electrode 43 in the second direction D2. FIG. 7 illustrates, with a solid line, the phase difference of the emission light L passing through the liquid crystal layer 30 when the phase of the emission light L passing between the first electrode 42 and the corresponding third electrode 61 is regarded as a reference (zero).

As illustrated in FIG. 7, since the magnitude of the second potential difference is larger than the magnitude of the first potential difference (ED1<ED2), the phase difference of the emission light L increases toward the positive D2 side between the first electrode 42 and the second electrode 43. In other words, the phase of the emission light L passing through the liquid crystal layer 30 advances toward the positive D2 side between the first electrode 42 and the second electrode 43. Accordingly, the emission light L is refracted to be emitted in the fourth direction D4.

In a case where the liquid crystal element 1 refracts the emission light L to travel in a fifth direction D5 tilted to the positive D2 side relative to the third direction D3, voltage is applied to the electrodes such that the magnitude of the first potential difference is larger than the magnitude of the second potential difference (ED2<ED1). In this case, voltage is applied to the first electrodes 42, the second electrodes 43, the third electrodes 61, and the fourth electrodes 62 such that the potential of the first electrodes 42 is different from the potential of the second electrodes 43 and the potential of the third electrodes 61 is different from the potential of the fourth electrodes 62. In this case, the electrode potential relation may be the relation represented by Expressions (3) and (4) below.

$$E 3 < E 2 < E 1 = E 4 \qquad ( 3 )$$

$$E 1 = ( - 1 ) \times E 3 \qquad ( 4 )$$

When the electrode potential relation satisfies the relation of Expressions (3) and (4), the electrode potential can be controlled by the column inversion driving method in which the polarity of the electrode potential is periodically inverted. The electrode potential relation is not limited to the relation of Expressions (3) and (4).

Since the magnitude of the first potential difference is larger than the magnitude of the second potential difference, the phase difference of the emission light L increases from the second electrode 43 toward the negative D2 side. In other words, the phase of the emission light L passing through the liquid crystal layer 30 advances from the second electrode 43 toward the negative D2 side. Accordingly, the emission light L is refracted to be emitted in the fifth direction D5.

In this manner, the liquid crystal element 1 can easily adjust the emission direction of the emission light L by controlling voltage applied to the electrodes.

The following describes the configuration of a liquid crystal element 2 of a comparative example.

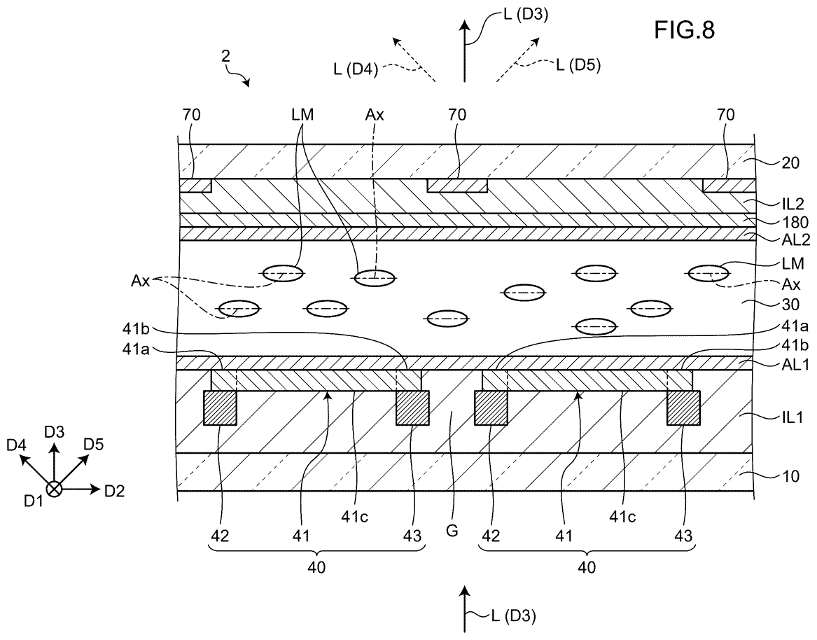

FIG. 8 is a sectional view of the liquid crystal element 2 of the comparative example. The liquid crystal element 2 of the comparative example differs from the above-described liquid crystal element 1 in that the liquid crystal element 2 of the comparative example does not include the third electrodes 61 and the fourth electrodes 62 but includes a fifth electrode 180.

The fifth electrode 180 is disposed between the second substrate 20 and the second alignment film AL2 and overlaps the element sets 40 in plan view.

When the liquid crystal element 2 of the comparative example refracts the emission light L from the light source S, voltage is applied to the first electrodes 42, the second electrodes 43, and the fifth electrode 180 such that the magnitude of a third potential difference between the potential of the first electrodes 42 and the potential of the fifth electrode 180 is different from the magnitude of a fourth potential difference between the potential of the second electrodes 43 and the potential of the fifth electrode 180. In other words, voltage is applied to the electrodes such that the potential of the first electrodes 42 is different from the potential of the second electrodes 43.

For example, when the liquid crystal element 2 of the comparative example refracts the emission light L to travel in the fourth direction D4, voltage is applied to the electrodes such that the magnitude of the fourth potential difference is larger than the magnitude of the third potential difference.

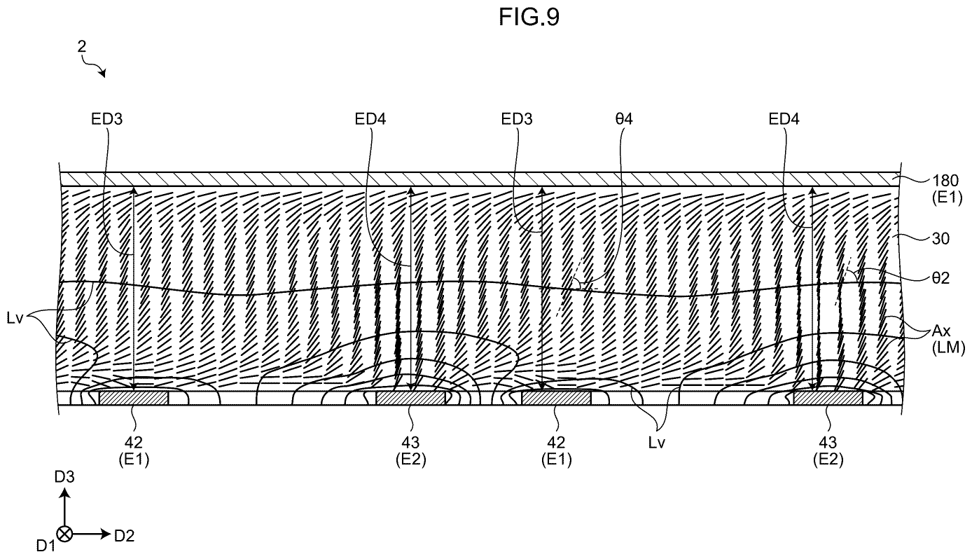

FIG. 9 is a diagram illustrating the tilt degree of the liquid crystal molecules LM when the liquid crystal element 2 of the comparative example refracts the emission light L in the fourth direction D4. In FIG. 9, the potential of the first electrodes 42 is equal to the potential (E1) of the first electrodes 42 illustrated in FIG. 6, and the potential of the second electrodes 43 is equal to the potential (E2) of the second electrodes 43 illustrated in FIG. 6. Accordingly, in FIG. 9, the potential of the second electrodes 43 is larger than the potential of the first electrodes 42. In FIG. 9, the potential of the fifth electrode 180 is equal to the potential (E1) of the first electrodes 42. Accordingly, the magnitude (ED4 (=|E2−E1|)) of the fourth potential difference is larger than the magnitude (ED3 (=|E1−E1|)) of the third potential difference (ED4>ED3).

The following describes comparison between the above-described liquid crystal element 1 illustrated in FIG. 6 and the liquid crystal element 2 of the comparative example illustrated in FIG. 9. The potential (E1) of the first electrodes 42 and the potential (E2) of the second electrodes 43 in the above-described liquid crystal element 1 are respectively equal to the potential (E1) of the first electrodes 42 and the potential (E2) of the second electrodes 43 in the liquid crystal element 2 of the comparative example.

The magnitude (ED2 (=|E4−E2|)) of the second potential difference in the above-described liquid crystal element 1 is larger than the magnitude (ED4 (=|E2−E1|)) of the fourth potential difference in the liquid crystal element 2 of the comparative example (ED2>ED4). Accordingly, the tilt degree (θ1; FIG. 6) of the liquid crystal molecules LM between the second and fourth electrodes 43 and 62 in the above-described liquid crystal element 1 is larger than the tilt degree (θ2; FIG. 9) of the liquid crystal molecules LM between the second and fifth electrodes 43 and 180 in the liquid crystal element 2 of the comparative example (θ1>θ2).

Moreover, in the above-described liquid crystal element 1, potential difference in the second direction D2 occurs between the third and fourth electrodes 61 and 62 adjacent to each other since the potential (E3) of the third electrode 61 is different from the potential (E4) of the fourth electrode 62. This potential difference acts on the liquid crystal molecules LM positioned between the first and third electrodes 42 and 61 to decrease the tilt degree (θ3; FIG. 6) of the liquid crystal molecules LM.

As described above, the liquid crystal element 2 of the comparative example does not include the third electrodes 61 and the fourth electrodes 62 but includes the fifth electrode 180. Thus, no potential difference in the second direction D2 occurs in the vicinity of the fifth electrode 180. Accordingly, the tilt degree (θ3; FIG. 6) of the liquid crystal molecules LM between the first and third electrodes 42 and 61 in the above-described liquid crystal element 1 is smaller than the tilt degree (θ4; FIG. 9) of the liquid crystal molecules LM between the first and fifth electrodes 42 and 180 in the liquid crystal element 2 of the comparative example (θ3<θ4).

FIG. 7 illustrates, with a dashed line, the phase difference of the emission light L passing through the liquid crystal layer 30 in the liquid crystal element 2 of the comparative example illustrated in FIG. 9. Specifically, FIG. 7 illustrates, with a dashed line, the phase difference of the emission light L passing through the liquid crystal layer 30 in the liquid crystal element 2 of the comparative example when the phase of the emission light L passing between the first and fifth electrodes 42 and 180 is regarded as a reference (zero). In FIG. 7, a part where the solid line illustrating the phase difference of the emission light L in the above-described liquid crystal element 1 overlaps the dashed line illustrating the phase difference of the emission light L in the liquid crystal element 2 of the comparative example is illustrated with a solid line.

Since the tilt degree of the liquid crystal molecules LM has the above-described relation (θ1>θ2 and θ3<θ4) between the above-described liquid crystal element 1 and the liquid crystal element 2 of the comparative example, the tilt degree of the liquid crystal molecules LM between the first electrode 42 and the second electrode 43 has such a difference that the tilt degree difference (θ1−θ3) in the above-described liquid crystal element 1 is larger than the tilt degree difference (θ2−θ4) in the liquid crystal element 2 of the comparative example. Accordingly, as illustrated in FIG. 7, the maximum value (PD1) of the phase difference of the emission light L in the above-described liquid crystal element 1 is larger than the maximum value (PD2) of the phase difference of the emission light L in the liquid crystal element 2 of the comparative example.

As described above, the potential (E1) of the first electrodes 42 and the potential (E2) of the second electrodes 43 in the above-described liquid crystal element 1 are respectively equal to the potential (E1) of the first electrodes 42 and the potential (E2) of the second electrodes 43 in the liquid crystal element 2 of the comparative example. Furthermore, the magnitude (ED1) of the first potential difference between the potential (E1) of the first electrodes 42 and the potential (E3) of the third electrodes 61 in the above-described liquid crystal element 1 is equal to the magnitude (ED4) of the fourth potential difference between the potential of the second electrodes 43 (E2 (=E3)) and the potential of the fifth electrode 180 (E1) in the liquid crystal element 2 of the comparative example. This means that the above-described liquid crystal element 1 can efficiently refract the emission light L as compared to the liquid crystal element 2 of the comparative example.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, voltage may be applied to the electrodes such that the potential of the third electrodes 61 is equal to the potential of the fourth electrodes 62.

The liquid crystal element 1 does not necessarily need to include the light-shielding films 70.

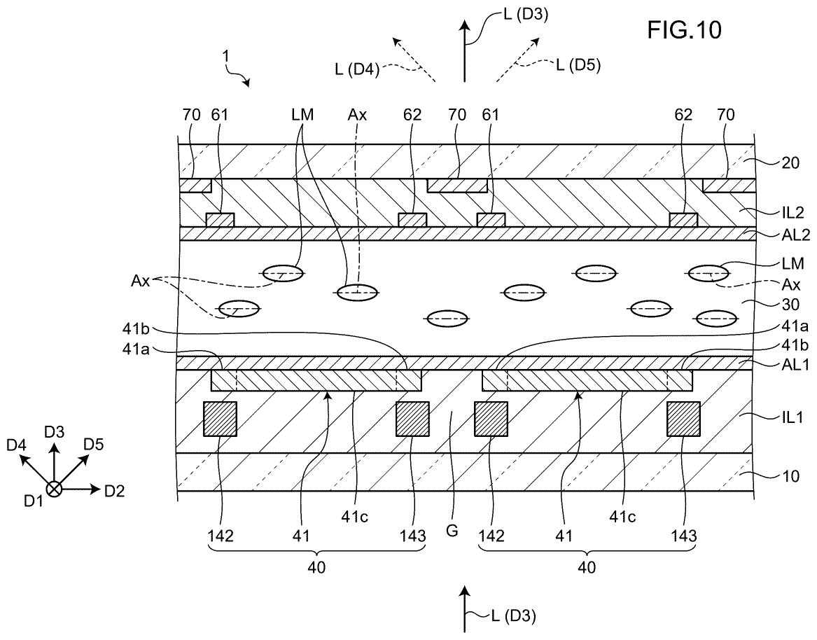

FIG. 10 is a sectional view of the liquid crystal element 1 according to a first modification of the embodiment of the present disclosure. The liquid crystal element 1 of the first modification differs from the liquid crystal element 1 of the above-described embodiment in that first electrodes 142 and second electrodes 143 are electrically coupled to the electric resistance films 41 in a state of being separated from the electric resistance films 41.

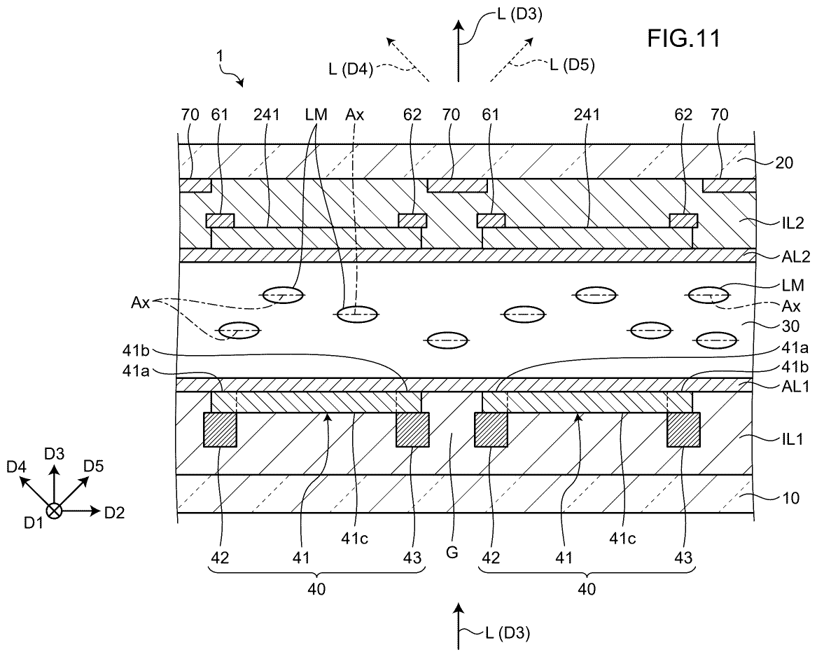

FIG. 11 is a sectional view of the liquid crystal element 1 according to a second modification of the embodiment of the present disclosure. The liquid crystal element 1 of the second modification differs from the liquid crystal element 1 of the above-described embodiment in that the liquid crystal element 1 of the second modification further includes a plurality of second electric resistance films 241.

The second electric resistance films 241 are disposed on the second substrate 20. The second electric resistance films 241 have the same shape as the electric resistance films 41. The electric resistance value of the second electric resistance films 241 is larger than the electric resistance values of the third and fourth electrodes 61 and 62. The material of the second electric resistance films 241 is the same as that of the electric resistance films 41. Similarly to the electric resistance films 41, the second electric resistance films 241 are arranged in a matrix having a row-column configuration in the first direction D1 and the second direction D2 in plan view.

In each second electric resistance film 241, the third and fourth electrodes 61 and 62 are electrically coupled to the second electric resistance film 241 in a state in which the third and fourth electrodes 61 and 62 face each other in the second direction D2. The third and fourth electrodes 61 and 62 contact the second electric resistance films 241. In the second modification, the material of the third and fourth electrodes 61 and 62 is a conductive material such as molybdenum tungsten alloy (MoW) or TAT (Ti/Al/Ti) in which titanium (Ti) and aluminum (Al) are stacked. The second alignment film AL2 is disposed on the negative D3 side of the second electric resistance films 241.

In the second modification, the first electrode 42 and the second electrode 43 may be electrically coupled to the electric resistance film 41 in a state in which the first electrode 42 and the second electrode 43 are separated from the electric resistance film 41, and the third and fourth electrodes 61 and 62 may be electrically coupled to the second electric resistance films 241 in a state in which the third and fourth electrodes 61 and 62 are separated from the second electric resistance films 241.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate on which a plurality of element sets each including an electric resistance film, a first electrode, and a second electrode are disposed, the first electrode and the second electrode being electrically coupled to the electric resistance film;
a second substrate on which a plurality of third electrodes and a plurality of fourth electrodes are disposed; and
a liquid crystal layer positioned between the first substrate and the second substrate, wherein
the electric resistance film extends in a first direction in plan view,
the first electrode and the second electrode, in plan view, extend in the first direction and overlap the electric resistance film in a state in which the first electrode and the second electrode face each other in a second direction orthogonal to the first direction,
the element sets are arranged in the second direction in plan view,
each of the third electrodes extends in the first direction and overlaps the first electrode of a corresponding one of the element sets in plan view, and
each of the fourth electrodes extends in the first direction and overlaps the second electrode of a corresponding one of the element sets in plan view.

2. The liquid crystal element according to claim 1, wherein the first electrode and the second electrode contact the electric resistance film.

3. The liquid crystal element according to claim 1, wherein voltage is applied to each of the first electrodes, each of the second electrodes, each of the third electrodes, and each of the fourth electrodes such that magnitude of a first potential difference between a potential of the first electrode and a potential of the third electrode is different from magnitude of a second potential difference between a potential of the second electrode and a potential of the fourth electrode.

4. The liquid crystal element according to claim 1, wherein voltage is applied to each of the first electrodes, each of the second electrodes, each of the third electrodes, and each of the fourth electrodes such that a potential of the first electrode is different from a potential of the second electrode and a potential of the third electrode is different from a potential of the fourth electrode.

5. The liquid crystal element according to claim 1, further comprising a light-shielding film that overlaps a gap between two of the electric resistance films adjacent to each other in the second direction in plan view and interrupts light transmission.

6. The liquid crystal element according to claim 1, further comprising second electric resistance films disposed on the second substrate and electrically coupled to the third electrodes and the fourth electrodes.
